(19) United States
(12) Patent Application Publication
(10) Pub. No.: US 2010/0153479 A1
(43) Pub. Date: Jun. 17, 2010

(54) APPARATUS FOR SETTING UP START POINT OF FAST FOURIER TRANSFORM AND METHOD THEREOF

(75) Inventors: Yong Su LEE, Daejeon (KR); Young-il KIM, Daejeon (KR); Seungkwon CHO, Guri-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/549,309

(22) Filed: Aug. 27, 2009

(30) Foreign Application Priority Data
Dec. 11, 2008 (KR) 10-2008-0126115
Mar. 25, 2009 (KR) 10-2009-0025591

(51) Int. Cl. G06F 17/14

(52) U.S. Cl. 708/404

(57) ABSTRACT

Disclosed are a fast Fourier transform (FFT) start point setting apparatus, and a method thereof. An FFT start point according to a synchronization acquisition result is moved to a CP direction by a predetermined sample offset and perform FFT.

### CROSS-REFERENCE TO RELATED APPLICATION

This application claims priority to and the benefit of Korean Patent Application Nos. 10-2008-0126115 and 10-2009-0025591 filed in the Korean intellectual Property Office on Dec. 11, 2008 and Mar. 25, 2009, the entire contents of which are incorporated herein by reference.

### BACKGROUND OF THE INVENTION

(a) Field of the Invention

The present invention relates to a fast Fourier transform (FFT) start point setting apparatus and a method thereof.

(b) Description of the Related Art

When a fast Fourier transform (FFT) start point is set not to a cyclic prefix (CP) duration but to a data duration due to a frame synchronization error that occurs in a downlink partial usage sub-channel (PUSC) of a WiBro system, severe performance degradation occurs.

However, no conventional method for solving this problem has been provided. That is, no detailed method for determining an appropriate offset toward the CP from the FFT start point in preparation for the frame synchronization acquisition error has been provided.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a fast Fourier transform (FFT) start point setting apparatus for realizing a receiving device that minimizes a frame synchronization acquisition error, and a method thereof.

According to an exemplary embodiment of the present invention, a FFT start point setting apparatus is provided. The FFT start point setting apparatus includes: a start point determining unit that moves a FFT start point according to a synchronization acquisition result by a predetermined sample offset toward a cycle prefix (CP) direction; and a FFT unit that receives the FFT start point moved by the start point determining unit and performs FFT based on the EFT start point.

According to another exemplary embodiment of the present invention, a FFT start point setting method is provided. The FFT start point setting method includes: determining a predetermined sample offset for movement of an FFT start point according to a synchronization acquisition result toward a cyclic prefix (CP) direction; moving the determined FFT start point toward the CP direction by the predetermined sample offset when the FFT start point is determined; and performing FFT from the moved FFT start point.

### BRIEF DESCRIPTION OF THE DRAWINGS

FIG. 1 shows a fast Fourier transform (FFT) start point according to an exemplary embodiment of the present invention.

FIG. 2 shows a performance graph in QPSK according to the exemplary embodiment of the present invention.

FIG. 3 shows a performance graph in 16 QAM according to the exemplary embodiment of the present invention.

FIG. 4 shows movement of an FFT start point according to the exemplary embodiment of the present invention.

FIG. 5 is a block diagram of an FFT start point setting apparatus according to an exemplary embodiment of the present invention.

FIG. 6 is a flowchart of an FFT start point setting method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Hereinafter, a fast Fourier transform start point setting apparatus and a method thereof according to an exemplary embodiment of the present invention will be described in detail with reference to the drawings.

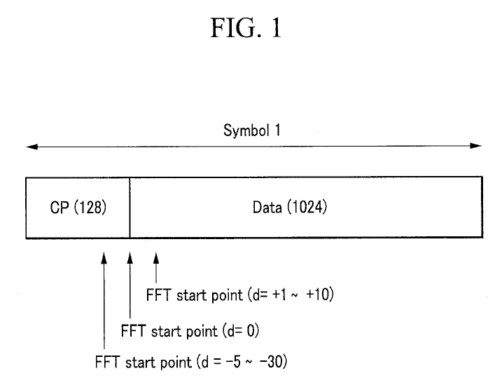

FIG. 1 shows a fast Fourier transform start point according to an exemplary embodiment of the present invention.

As shown in FIG. 1, a fast Fourier transform is optimal when a fast Fourier transform (hereinafter referred to as FFT) start point is d=0, but the FFT start point is charged according to a frame synchronization acquisition point.

When a frame synchronization error is detected in a partial usage sub-channel (PUSC) of a downlink receiving unit of a WIBRO system and the error is determined to be generated due to unstable frame synchronization acquisition as a result of channel estimation by using a simple channel estimation method such as a least squares method and a linear interpolation method, the FFT start point moves to a cyclic prefix (CP) duration if synchronization is acquired before an accurate synchronization point. When synchronization is acquired after this, the FFT start point is located in a data duration.

If the FFT start point is located in the data duration (d=+1−+10), the system performance is severely deteriorated due to inter-carrier interference (ICI).

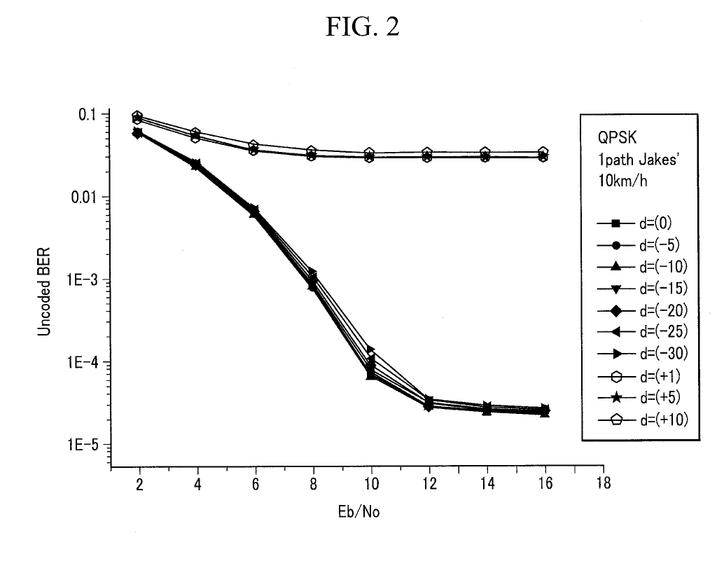

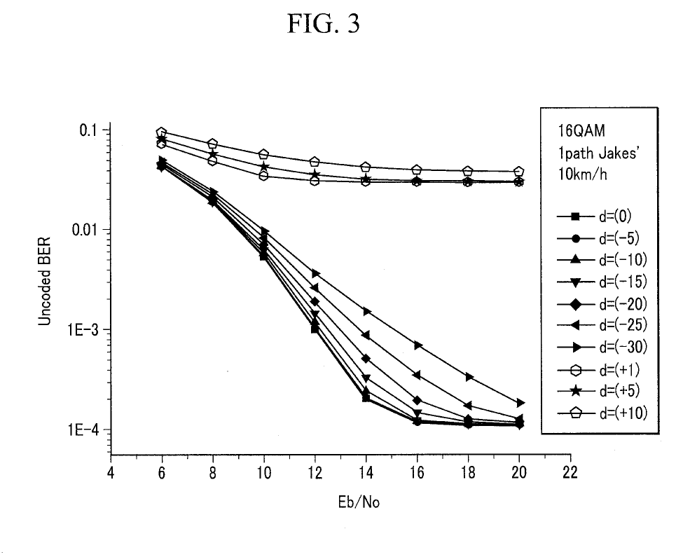

Theoretically, a problem may not occur when the FFT start point is located in the CP duration, but the LS method, which is a unstable method, is used for channel estimation due to speed in the Wibro system so that performance difference occurs according to the FFT start point, as shown in FIG. 2 and FIG. 3.

FIG. 2 shows a performance graph in a quadrature phase shift keying (QPSK) system according to the exemplary embodiment of the present invention, and FIG. 3 shows a performance graph in a 16 quadrature amplitude modulation (QAM) system according to the exemplary embodiment of the present invention. In this case, the horizontal axis denotes a signal to noise ratio (SNR) that indicates a ratio of bit energy (Eb) and noise (No), and the vertical axis denotes a bit error rate (BER).

Referring to FIG. 2, a performance degradation difference is less than 0.2 dB for a d=−15 sample in the QPSK system.

In addition, referring to FIG. 3, a performance degradation difference is small for a d=−10 sample in the 16 QAM system.

As described, it can be checked through simulations that the system performance is not influenced even though frame synchronization acquisition is generated and thus an offset to the CP duration occurs.

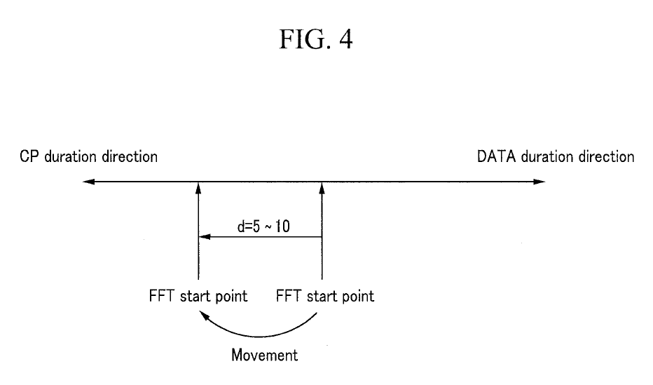

FIG. 4 shows movement of the FFT start point according to the exemplary embodiment of the present invention.

Referring to FIG. 4, the FFT start point is moved by artificially providing an appropriate offset toward the CP duration. In this way, the FFT start point can be prevented from being located not in the CP duration but in the DATA duration due to a frame synchronization error, thereby preventing severe performance degradation.

Here, a range of the appropriate offset is determined based on the simulation results of FIG. 2 and FIG. 3, and it is preferred to provide 5 to 10 samples toward the CP duration from the FFT start point according to the exemplary embodiment of the present invention.

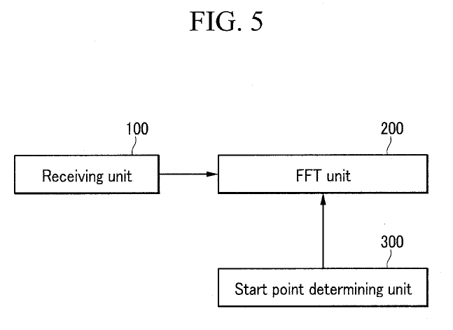

FIG. 5 is a block diagram of a configuration of a FFT start point setting apparatus according to the exemplary embodiment of the present invention.

Referring to FIG. 5, the FFT start point setting apparatus includes a receiving unit 100, an FFT unit 200, and a start point determining unit 300.

When the receiving unit 100 receives a signal and transmits the received signal, the FFT unit 200 performs FFT on a location determined by the start point determining unit 300.

The start point determining unit 300 determines an FFT start point as shown in FIG. 4. That is, the start point determining unit 300 determines the FFT start point by providing 5 to 10 samples toward the CP duration from an FFT start point set according to a synchronization acquisition result. Therefore, the FFT start point can be prevented from being moved to the DATA duration due to an unstable synchronization acquisition error.

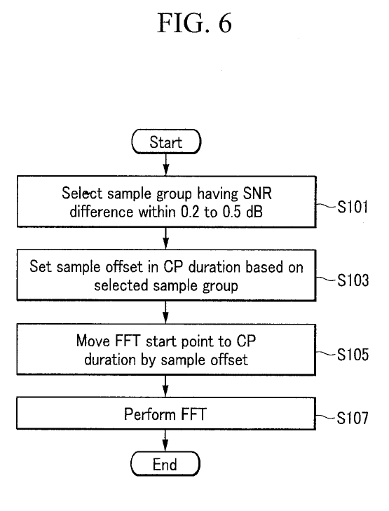

FIG. 6 is a flowchart of an FFT start point setting method according to the exemplary embodiment of the present invention.

Referring to FIG. 6, the start point determining unit 300 of FIG. 5 selects sample groups with d=0 samples and samples having an SNR difference within 0.2 to 0.5 dB based on simulation values of the samples in FIG. 2 and FIG. 3 (S101).

The start point determining unit 300 sets a sample offset value to the CP duration based on the sample groups selected in step S101 (S103). According to the exemplary embodiment, it is preferred to set the sample offset to d=5 to 10.

When a signal is received through the receiving unit 100, the start point determining unit 300 moves the FFT start point according to the synchronization acquisition result by the sample offset set in step S103 (S107).

The FFT unit 200 receives the FFT start point determined by the start point determining unit 300 in step S107 and performs FFT (S109).

According to the exemplary embodiments of the present invention, a receiving device that is robust to a frame synchronization acquisition error can be provided by artificially setting a FFT start point of a receiving end with an appropriate offset toward the CP duration.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fast Fourier transform (FFT) start point setting apparatus, comprising:
a start point determining unit that moves an FFT start point according to a synchronization acquisition result by a predetermined sample offset toward a cycle prefix (CP) direction; and
an FFT unit that receives the FFT start point moved by the start point determining unit and performs FFT based on the FFT start point.

2. The FFT start point setting apparatus of claim 1, wherein the start point determining unit determines a predetermined sample offset by using a signal to noise ratio (SNR).

3. The FFT start point setting apparatus of claim 2, wherein the start point determining unit selects a plurality of samples having an SNR in a predetermined decibel (dB) range, and determines a sample duration formed of a plurality of samples by the predetermined sample offset.

4. A fast Fourier transform (FFT) start setting method comprising, determining a predetermined sample offset for movement of an FFT start point according to a synchronization acquisition result toward a cyclic prefix (CP) direction;
moving the determined FFT start point toward the CP direction by the predetermined sample offset when the FFT start point is determined; and
performing FFT from the moved FFT start point.

5. The FFT start point setting method of claim 4, wherein the determining of the predetermined sample offset uses a signal to noise ratio (SNR) to determined the predetermined sample offset.

6. The FFT start point setting method of claim 5, comprising:
selecting a plurality of samples having an SNR in a predetermined decibel (dB) range; and
setting a sample duration formed of the plurality of samples by the sample offset in the CP duration.
